(19) United States
(12) Patent Application Publication
(10) Pub. No.: US 2008/0184150 A1
(43) Pub. Date: Jul. 31, 2008

(54) ELECTRONIC CIRCUIT DESIGN ANALYSIS TOOL FOR MULTI-PROCESSOR ENVIRONMENTS

(76) Inventors: Marc Minato, West Linn, OR (US); Russell Alan Klein, West Linn, OR (US)

Correspondence Address: KLARQUIST SPARKMAN, LLP, 121 S.W. SALMON STREET, SUITE 1600, PORTLAND, OR, 97204, US

(21) Appl. No.: 11/929,764

(22) Filed: Oct. 30, 2007

Related U.S. Application Data
(60) Provisional application No. 60/898,784, filed on Jan. 31, 2007.
(60) Provisional application No. 60/971,210, filed on Sep. 10, 2007.
(60) Provisional application No. 60/979,781, filed on Oct. 12, 2007.

(51) Int. Cl. G06F 3/048; G06F 17/50

(52) U.S. Cl. 715/771; 703/15

(57) ABSTRACT

One or more technologies described herein can be used for viewing results of a simulation of a software executable in a multi-processor electronic circuit design. A debug environment can display simulation results related to the multiple processors, for example, as a correlated software debug view of the processors. In at least some embodiments, the disclosed technologies can be used to examine a correlation between an error in the design which is shown in the simulation results and one or more inter-processor synchronization events.

### CROSS-REFERENCE TO RELATED APPLICATIONS

This application claims the benefit of: U.S. Provisional Application No. 60/898,784, titled “Simulation Display Tool” and filed Jan. 31, 2007; U.S. Provisional Application No. 60/971,210, titled “Simulation Display Tool in Multi-Processor Environments” and filed Sep. 10, 2007; and U.S. Provisional Application No. 60/979,781, titled “Simulation Display Tool in Multi-Processor Environments” and filed Oct. 12, 2007, all of which are incorporated herein by reference.

### FIELD

The disclosed technologies relate to analyzing an electronic circuit design.

### BACKGROUND

Logic simulation tools are often used for analyzing an electronic circuit design. For example, a simulator can receive a description of inputs (e.g., commands, data values) to be applied to a description of the circuit design. Simulator outputs can be compared to expected values to determine if the circuit design is functioning properly. However, the outputs of a circuit design simulation (e.g., values simulated as appearing on one or more output pins of the simulated circuit design) often provide an incomplete picture of simulated operations taking place within the design. For example, a particular design can be configured to provide one or more register values to output pins, but values from a cache may be unavailable. Determining such values from simulation results, even if the architecture of the circuit design is known, can be a difficult and laborious task, particularly when there are a large number of results or when a simulation is relatively long.

As multi-processor systems become more prevalent, debugging software running on these systems is becoming more important. Correlating the activity of algorithms that span multiple processors, and sometimes other multiple hardware components, can be difficult using conventional tools. Additionally, tools that have been shown to be effective in analyzing single-processor circuit designs may not accurately analyze multi-processor designs due to, for example, concurrent executions, which can cause problems such as race conditions, shared data conflicts, deadlock, concurrent priorities, and priority inversion. Generally, current debugging solutions do not concurrently display a given state in multiple processors of a circuit design.

### SUMMARY

Results of a simulation of a software executable in an electronic circuit design can be presented and used to determine values simulated as being stored, such as in the memory and registers of the design, including values that are not necessarily observable on the outputs of the design. In some embodiments, a user can indicate a time period in the simulation results, or a portion of the software executable. One or more values simulated as being stored in the design can be determined according to the circuit design, a description of one or more transactions of values stored in the circuit design, and one or more indications of signals provided on the outputs of the design. This can allow a user to examine values simulated as being stored in the circuit design using, for example, a software debugger showing register and memory watches.

One or more technologies described herein can be used for viewing results of a simulation of a software executable in a multi-processor electronic circuit design. A debug environment can display simulation results related to the multiple processors, for example, as a correlated software debug view of the processors. In at least some embodiments, the disclosed technologies can be used to examine a correlation between an error in the design which is shown in the simulation results and one or more inter-processor synchronization events. Technologies described herein can also be used for analyzing results obtained from emulated circuit design components and/or physical circuit design components.

In some embodiments, a system for analyzing results of a simulation of an electronic circuit design, comprising a first processor, a second processor and one or more additional hardware component, comprises: a logic simulator configured to display simulation results for the one or more additional hardware components; a first software debugger program configured to display information comprising simulation results related to the first processor or information describing a simulated status of a software program simulated as being executed on the first processor; a second software debugger program configured to display information comprising simulation results related to the second processor or information describing a simulated status of a software program simulated as being executed on the second processor; and one or more software components configured to communicate changes in displayed information in one of the logic simulator, the first debugger program and the second debugger program to the others of the logic simulator, the first debugger program and the second debugger program. In particular embodiments the system further comprises a software component configured to receive a command to change information displayed in one of the logic simulator, the first debugger program and the second debugger program. Sometimes the software component configured to receive the command to change information displayed is on a first computer, and wherein at least one of the logic simulator, the first debugger program, the second debugger program and the one or more software components configured to communicate changes in displayed information is on a second computer. The command is sometimes a step command or a backward step command. In some cases the simulation results for the one or more additional hardware components are obtained using a clock-cycle accurate model of the additional hardware components.

In further embodiments, one or more computer-readable media comprise instructions configured to cause a computer to perform a method for analyzing results of a simulation of a first software program being executed on a first processor in an electronic circuit design and a second software program being executed on a second processor in the electronic circuit design, the method comprising: receiving a first indication of simulation results for the first processor at a first indicated time; identifying one or more simulation results for the second processor according to a description of a plurality of values simulated as being stored in the electronic circuit design, wherein the identified one or more simulation results for the second processor correspond at least approximately to the first indicated time; and storing the identified one or more simulation results for the second processor in one or more computer-readable media. In some embodiments the description of a plurality of values simulated as being stored in the electronic circuit design comprises: at least one time indicator for the simulation; a first write address indicator identifying first one or more data storage locations described in the electronic circuit design; a second write address indicator identifying second one or more data storage locations described in the electronic circuit design; a first write value indicator identifying one or more values simulated as being written by the first processor to the first one or more data storage locations described in the electronic circuit design; and a second write value indicator identifying one or more values simulated as being written by the second processor to the second one or more data storage locations described in the electronic circuit design.

In additional embodiments one or more computer-readable media comprise instructions configured to cause a computer to display a user interface for displaying results of a simulation of an electronic circuit design, the user interface comprising: a region configured to display at least a portion of the simulation results; a first indicator in a first position on the display associated with an approximate chronological point in the simulation results for which the description of the plurality of values simulated as being stored in the electronic circuit design indicates that simulation results are available for a first processor in the electronic circuit design; and a second indicator in a second position on the display, wherein the second position is associated with an approximate chronological point in the simulation results for which a description of a plurality of values simulated as being stored in the electronic circuit design indicates that simulation results are available for a second processor in the electronic circuit design. In particular embodiments the first position is a user-selected position. In additional embodiments the display comprises a timeline. For some cases, the user interface further comprises a third indicator in a third position on the display, and wherein the third position is a user-selected position. The first indicator is displayed at the first position before the third indicator is displayed at the third position. Sometimes, the first indicator and the third indicator are displayed such that the third indicator appears to move from the third position to the first position. In some embodiments the user interface further comprises a region displaying test result data associated with the first processor. In further embodiments the user interface further comprises an indication of a synchronization event between the first processor in the electronic circuit design and a second processor in the electronic circuit design.

A method of analyzing results of a simulation of an electronic circuit design comprises: displaying a first portion of simulation results for a first processor in the electronic circuit design; displaying a first portion of simulation results for a second processor in the electronic circuit design; displaying a first portion of simulation results for a non-processor component in the electronic circuit design; receiving an indication to display a second portion of simulation results for the first processor; and displaying the second portion of simulation results for the first processor, a second portion of simulation results for the second processor, and a second portion of simulation results for the non-processor component. The indication is received using a user interface element comprising a timeline showing availability of simulation results for at least part of the electronic circuit design. The indication corresponds to a point in time in the simulation results for which simulation results for the second processor are not available, and wherein the second portion of simulation results for the second processor comprises the simulation results for the second processor that are closest to the point in time in the simulation results. The method sometimes further comprises determining at least a part of the second portion of the simulation results for the first processor according to a description of values simulated as being stored in the electronic circuit design.

In additional embodiments, a method for analyzing a physical or emulated electronic circuit, the circuit comprising a first processor, a second processor, and one or more additional hardware components, comprises: displaying a first set of previous signal values produced by the one or more additional hardware components during operation of the electronic circuit design; displaying a first set of previous signal values generated as a result of a software program being executed on the first processor; displaying a first set of previous signal values generated as a result of a software program being executed on the second processor; receiving an indication to display and displaying one of a second set of previous signal values produced by the one or more additional hardware components during operation of the electronic circuit design, a second set of previous signal values generated as a result of a software program being executed on the first processor, or a second set of previous signal values generated as a result of a software program being executed on the second processor; and displaying the others of the second set of previous signal values produced by the one or more additional hardware components during operation of the electronic circuit design, the second set of previous signal values generated as a result of a software program being executed on the first processor, or the second set of previous signal values generated as a result of a software program being executed on the second processor.

Any of the methods described herein can be incorporated into one or more computer-readable media comprising instructions configured to cause one or more computers to perform some or all of the method acts.

### BRIEF DESCRIPTION OF THE DRAWINGS

FIG. 1 is a block diagram of an exemplary system for analyzing an electronic circuit design.

FIG. 2 is block diagram of an exemplary technique for displaying results of a simulation of an electronic circuit design.

FIG. 3 shows a portion of one exemplary embodiment of a data set.

FIG. 4 is a block diagram of one exemplary embodiment of a method for displaying circuit simulation results using a data set.

FIG. 5 shows exemplary embodiments of applications used for displaying simulation results of an electronic circuit design.

FIG. 6 is a block diagram of an exemplary computer network that can be used with technologies described herein.

FIG. 7 is a block diagram of an exemplary manner in which the network of FIG. 6 can be used to display results of a simulation of an electronic circuit design.

FIG. 8 is a block diagram conceptually illustrating a circuit description of a multi-processor electronic circuit design.

FIG. 9 shows a block diagram of one exemplary embodiment of a software system for analyzing simulation results in a multi-processor environment.

FIG. 10 shows a block diagram of one exemplary embodiment of a software system for analyzing simulation results in a multi-processor environment.

FIG. 11A shows a diagram depicting an exemplary availability of simulation results.

FIG. 11B shows exemplary timelines depicting simulation results between simulated points in time.

FIGS. 12A-12C show exemplary timelines depicting cursors for describing simulation results.

FIG. 13 shows exemplary embodiments of applications used for displaying simulation results of an electronic circuit design.

### DETAILED DESCRIPTION

Disclosed below are representative embodiments of methods, apparatus, and systems for displaying results of a simulation of an electronic circuit design that should not be construed as limiting in any way. Instead, the present disclosure is directed toward all novel and nonobvious features and aspects of the various disclosed methods, apparatus, and systems, alone and in various combinations and subcombinations with one another. The disclosed technology is not limited to any specific aspect or feature, or combination thereof, nor do the disclosed methods, apparatus, and systems require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may be rearranged or performed concurrently. Moreover, for the sake of simplicity, the attached figures may not show the various ways in which the disclosed methods, apparatus, and systems can be used in conjunction with other methods, apparatus, and systems. Additionally, the description sometimes uses terms like “determine,” “analyze” and “identify” to describe the disclosed technologies. These terms are high-level abstractions of the actual operations that are performed. The actual operations that correspond to these terms may vary depending on the particular implementation and are readily discernible by one of ordinary skill in the art.

As used in this application and in the claims, the singular forms “a,” “an” and “the” include the plural forms unless the context clearly dictates otherwise. Additionally, the term “includes” means “comprises.” Further, the term “coupled” means electrically or electromagnetically connected or linked and does not exclude the presence of intermediate elements between the coupled items. The phrase “and/or” means “one or more of” the set of items in which it occurs.

In at least some of the embodiments described below, when an operation is described as being performed on an electronic circuit design, this can mean that during a simulation of the design, the operation is simulated as being performed on the circuit described by the circuit design. For example, if a value is described as being “written” to the circuit or the circuit design, this can refer to the value being simulated as written to the circuit described by the design.

The disclosed embodiments can be implemented in a wide variety of environments. For example, any of the disclosed techniques can be implemented in software comprising computer-executable instructions stored on computer-readable media (e.g., one or more CDs, volatile memory components (such as DRAM or SRAM), or nonvolatile memory components (such as hard drives)). Such software can comprise, for example, electronic design automation (“EDA”) software (e.g., a logic simulator tool or a software debugger) used to diagnose test results captured during testing of one or more circuit designs (e.g., an application specific integrated circuit (“ASIC”), a programmable logic device (“PLD”) such as a field-programmable gate array (“FPGA”), or a system-on-a-chip (“SoC”) having digital, analog, or mixed-signal components thereon). This particular software implementation should not be construed as limiting in any way, however, as the principles disclosed herein are generally applicable to other software tools.

Such software can be executed on a single computer or on a networked computer (e.g., via the Internet, a wide-area network, a local-area network, a client-server network, or other such network). For clarity, only certain selected aspects of the software-based implementations are described. Other details that are well known in the art are omitted. For example, it should be understood that the disclosed technologies are not limited to any specific computer language, program, or computer. For the same reason, computer hardware is not described in further detail. For example, the disclosed embodiments can be implemented using a wide variety of commercially available computer systems and/or testing systems. Any of the disclosed methods can alternatively be implemented (partially or completely) in hardware (e.g., an ASIC, PLD, or SoC).

Further, diagnostic results (e.g., events simulated as occurring in an electronic circuit design, including values simulated as being stored in the design, as well as any intermediate diagnostic results) produced from any of the disclosed methods can be created, updated, or stored on computer-readable media (e.g., one or more CDs, volatile memory components (such as DRAM or SRAM), or nonvolatile memory components (such as hard drives)) using a variety of different data structures or formats. For example, a list of software instructions or memory values can be stored on computer readable-media. Such diagnostic results can be created or updated at a local computer or over a network (e.g., by a server computer). As used herein, the term “list” refers to a collection or arrangement of data that is usable by a computer system. A list can be, for example, a data structure or combination of data structures (such as a queue, stack, array, linked list, heap, or tree) that organizes data for better processing efficiency, or any other structured logical or physical representation of data in a computer system or computer-readable media (such as a table used in a relational database).

### Exemplary System and Method for Analyzing an Electronic Circuit Design

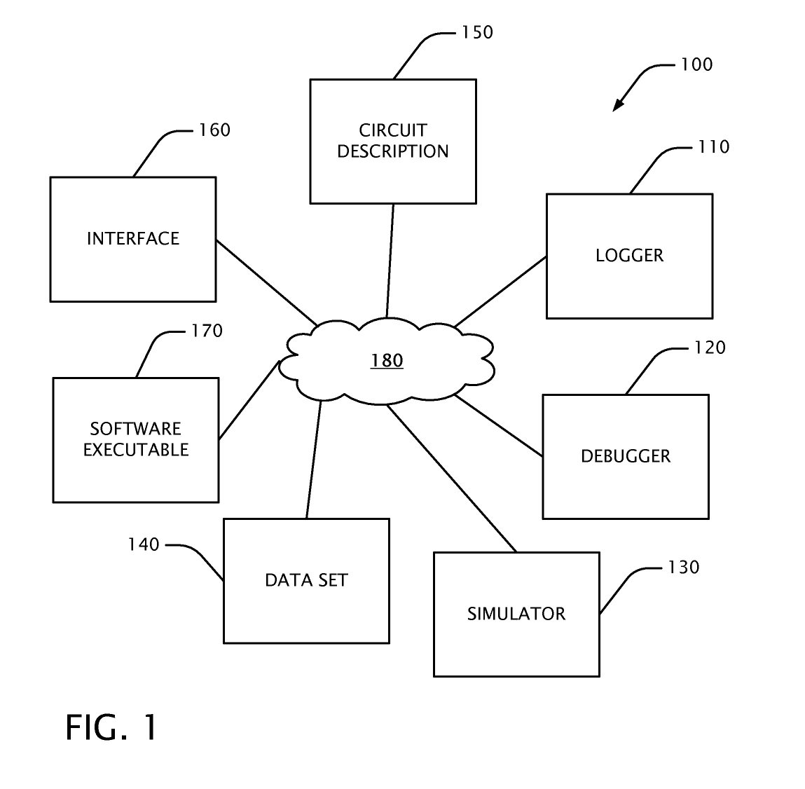

FIG. 1 is a block diagram of one embodiment of an exemplary system 100 for analyzing a circuit design. The system 100 comprises: a logger 110, which stores and/or displays recorded or stored outputs from a simulation of an electronic circuit design; and a debugger 120, which displays computer code and/or programming values (e.g., values simulated as being stored in storage elements, such as in registers and/or memory locations of the circuit design). In some embodiments, the logger 110 records or stores outputs from a simulator 130 (e.g., a logic simulator such as ModelSim® from Mentor Graphics Corp.). The system 100 can further comprise a data set 140, which generally describes changes made to values simulated as being stored in storage elements, such as in registers and/or memory locations in the circuit design, as explained in more detail below. A circuit description 150 of the electronic circuit design can be stored on one or more computer-readable media in a variety of formats, e.g., OASIS, GDSII, HDL, register transfer level (RTL) or other formats. In some embodiments the system 100 can further comprise an interface layer 160. The interface layer 160 can interact with some or all of the components in the system 100, and can generally facilitate exchange of information among the components. The interface layer 160 can be implemented as part of one or more of the other components (e.g., the logger 110 or the debugger 120) or as a separate component. One or more components in the system 100 can be configured to be indifferent as to the existence of the interface layer 160. A software executable 170 comprises at least a portion of the software executed on the electronic circuit design to produce the data set 140. The degree of interaction among the components of the system 100 can vary according to the embodiment, and data hub 180 symbolizes this versatility.

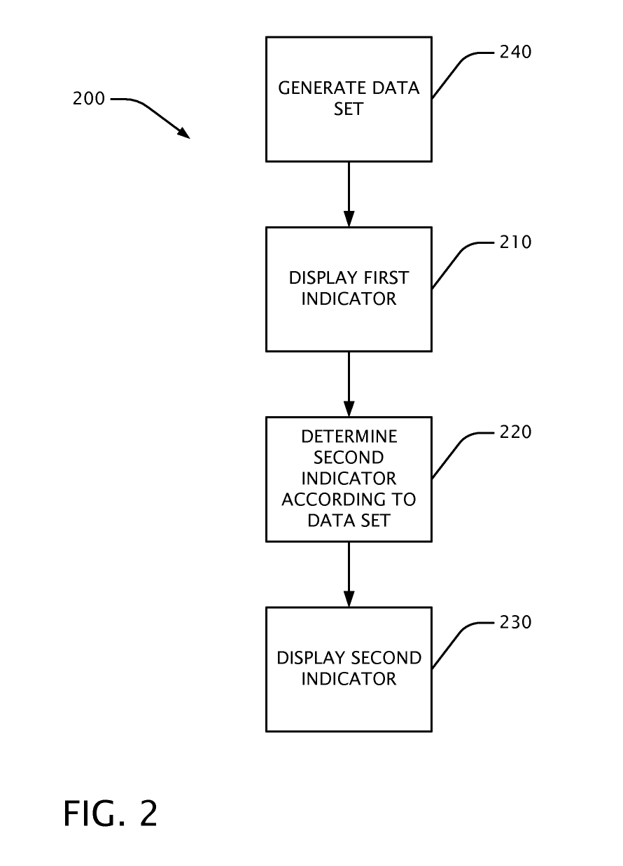

FIG. 2 shows a block diagram of one exemplary embodiment of a method 200 for displaying results of a simulation of an electronic circuit design. In method act 210, a “first indicator” is displayed, which can correspond to either: (1) information describing the state or status of the software executable 170 as simulated in the electronic circuit design (sometimes referred to herein as “status data” or “software status data”); or (2) one or more values corresponding to the results of the simulation. The status data for the software program can comprise, for example, software instructions (e.g., source code instructions, assembly code instructions and/or machine code instructions), register values, memory values, variable values, and/or other information that describes the state of the software executable 170 as simulated in the electronic circuit design. In some embodiments, the first indicator is provided as a result of user input. For example, a first indicator can result from: placing a cursor on one or more lines of software code in a debugger application window; stepping through a listing of software code in a debugger application window; or placing a cursor at one or more locations in a waveform viewer. In further embodiments such actions can be automated, e.g., using a script. In some embodiments, the values corresponding to the results of the simulation can take forms such as memory or register values, as well as waveforms or other graphical depictions of such values. In method act 220, a “second indicator” is determined according to a data set. The second indicator results from the first indicator and can be the other of the software status data or the one or more values corresponding to the results of the simulation. The second indicator can correspond at least in part to the first indicator. In method act 230, the second indicator is displayed and, in some embodiments, stored in one or more computer-readable media. In some embodiments, the method 200 further comprises generating a data set (method act 240), which is explained in more detail below.

Generally, the applications used in embodiments of method 200 for displaying the first and/or second indicators can be software applications useful for analyzing an electronic circuit design, including software for analyzing software instructions used in a simulation of the design. Example applications can include: a software debugger; a logic simulator (e.g., ModelSim®, CSim from Intel Corp., or VCS® from Synopsis, Inc.); and a waveform viewer (e.g., ModelSim®, Debussy® from Novis, Inc., or SimVision from Cadence, Inc.) for displaying simulation outputs as waveform and/or numerical values. In some embodiments, the applications operate as separate software applications, while in other embodiments the applications operate as one software application.

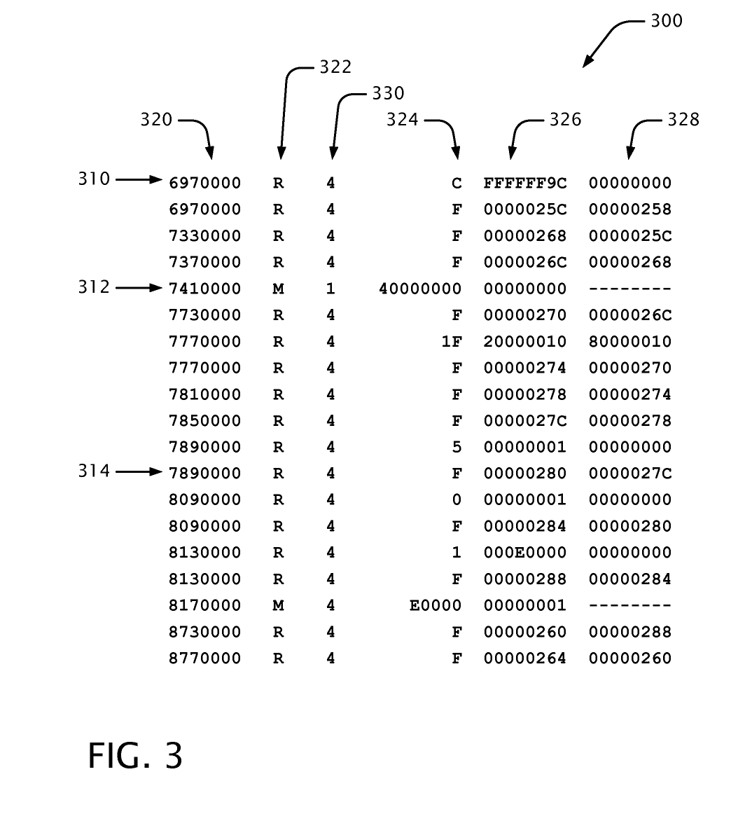

FIG. 3 shows a portion 300 of one exemplary embodiment of a data set. In some embodiments the data set can be generated (for example, as a log file) by a component (such as the logger 110) during or after the execution of the circuit design simulation and displayed or stored in one or more computer-readable media. In the depicted embodiment, information is stored in tuples (displayed in the depicted embodiment as rows 310, 312, 314) comprised of a plurality of data elements (displayed in the depicted embodiment in columns 320, 322, 324, 326, 328, 330). A tuple can contain information describing a simulated transaction in which a value is written to a storage location (e.g., a register location or a memory location described in the circuit design). In the depicted embodiment, elements in column 320 indicate times when the simulated transactions occurred. In some embodiments, the time can be a relative time, while in some embodiments the time is an absolute time. In the depicted embodiment, the time is expressed in picoseconds since the start of the simulation used to generate the data set. Elements shown in column 322 can indicate one or more destination types for the transactions. In the depicted embodiment, values in this column can indicate whether a transaction involves writing to a register location (as denoted by “R”) or to a memory location (as denoted by “M”). In further embodiments, elements such as those shown in the destination type column 322 can indicate that values can be simulated as being written to other storage locations such as: multiple memory spaces, e.g., tightly coupled memories (TCM) (often found in processors from ARM, Ltd.), scratchpad memories (often found in PowerPC processors from IBM, Inc.), or local memories (often found in processors from MIPS Technologies, Inc.); and additional register spaces, e.g., co-processor registers, memory management unit (MMU) registers, and cache control registers. Elements shown in column 324 can indicate one or more addresses to which the respective values in column 326 are simulated as being written. Addresses can include, e.g., register numbers (for register writes) and memory addresses (for memory writes).

Further data set embodiments can comprise some or all of the types of data shown in FIG. 3, as well as additional types of data. For example, the embodiment depicted in FIG. 3 further comprises a data element, shown in column 328, indicating a previously stored value for a register or memory location, e.g., a value stored in the address indicated in column 324 before it was overwritten by the value indicated in column 326. The depicted data set portion 300 can further comprise an element, shown here in a column 330, indicating a size (e.g., in bytes) of the data in column 326 that is being written to the destination specified in columns 322, 324.

The tuple shown as row 310 provides an example of data that can be stored in a data set. This data indicates that at a time 6970000, a value of FFFFFF9C, having a size of 4 bytes, was written to a register having an address C. Before this time, the value 00000000 was stored at this location. As another example, the data in row 312 describes a transaction at a time 7410000, in which a 1-byte value of 00 was written to a memory location at address 40000000. (In the depicted embodiment, some elements (e.g., elements shown in column 326) contain values comprising more characters than are necessary for describing a value. Further embodiments can be configured such that elements shown in one or more columns contain no more characters than necessary for describing a value.) The symbol “--------” appearing in column 328 for the tuple of row 312 indicates that, when the transaction described in the tuple of row 312 occurred, there was no prior value stored in the relevant location, e.g., the transaction described by the tuple of row 312 was the first time that the location was written to during the simulation.

In the depicted embodiment, register F is the program counter for the circuit design, and thus transactions modify values stored in this register relatively often (see, e.g., row 314).

Generally, the data set can be expressed and stored in a number of formats, including hexadecimal values, binary values, decimal values, text values and other formats. Some embodiments can express data in more than one format. In further embodiments at least some of the values are stored as absolute values, while in some embodiments at least some of the values are stored as difference values.

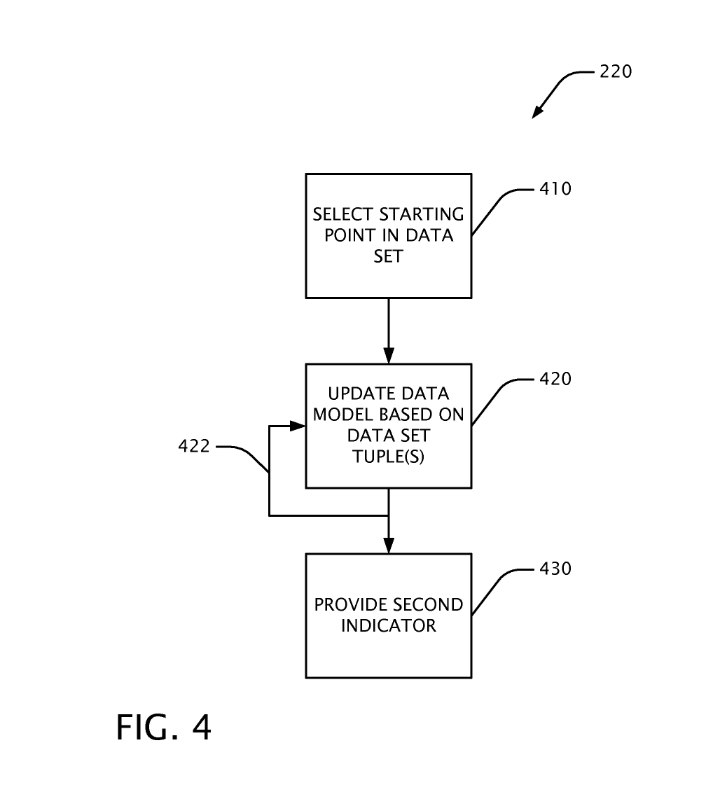

FIG. 4 is a block diagram of one exemplary embodiment of method act 220 from FIG. 2. In method act 410, a starting point in the data set is selected. Generally, the starting point (or “reference point”) reflects a time when some or all of the values stored in storage locations such as in registers and/or memory locations of the circuit described by the circuit description 150 are known. For example, in some embodiments the starting point can be selected to reflect a reset state, the beginning of a simulation, and/or a state when known values have been loaded into one or more registers and/or memory locations. In some cases (e.g., when the starting point is the beginning of a simulation), the starting point can be the beginning or near the beginning of the data set. In other cases, the starting point can be elsewhere in the data set. In method act 420, a data model (which can describe values simulated as being stored in the circuit design, e.g., in memory and/or register locations, and which can be part of the interface component 160) is updated based on information stored in one or more tuples (generally, one or more successive tuples) of a data set. As indicated by arrow 422, method act 420 can be repeated as necessary until the second indicator is determined. In method act 430, a second indicator is provided, which can comprise, for example, storing the second indicator in one or more computer-readable media and/or displaying the second indicator.

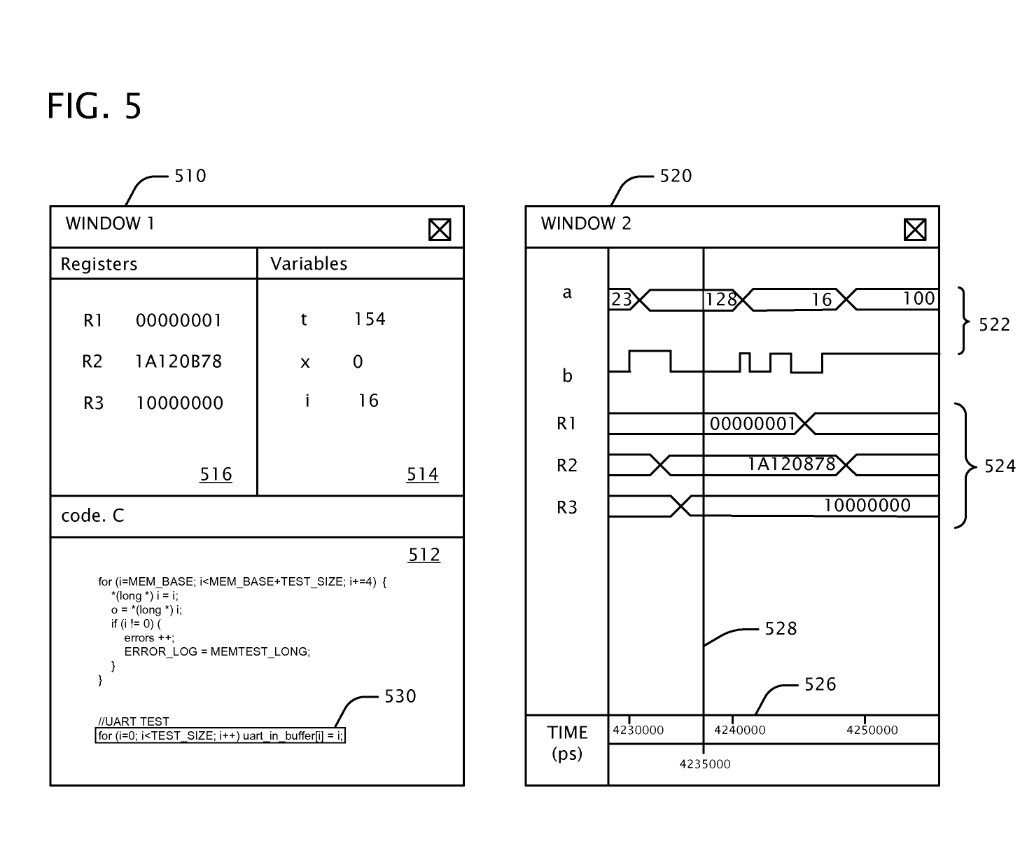

FIG. 5 shows embodiments of exemplary applications used in conjunction with embodiments described elsewhere in this application. In various embodiments, the applications can be presented with a number of user interfaces, though the applications in FIG. 5 use a window-based graphical user interface (GUI). A first application, which in some embodiments is a software debugger 120 or similar program, appears in a region such as a window 510. The window 510 can be broken into multiple regions such as windows, e.g., a source code window 512 (showing at least a portion of the code comprising the software executable 170), a variables watch window 514, and a registers watch window 516. A second application, which in some embodiments is a program that displays a waveform generated by a simulation, and can also display data related to the waveform (e.g., a logger 110), appears in window 520. In the depicted embodiment, the window 520 comprises variable waveforms 522 and register waveforms 524 presented along a time axis 526. In the depicted embodiment, the time axis 526 indicates the time (in ps) since the beginning of the simulation, but other forms of measurement can be used, such as a number of simulated clock cycles, for example. A cursor 528 can be placed at one or more points along the axis 526. In some embodiments, the cursor 528 can be used to visually correlate one or more values in the waveforms 522, 524 with the time axis 526 or with values in one or more other waveforms. For example, cursor 528 can be a line that intersects various waveforms and correlates these waveform values as the intersection of the cursor with a frame value on axis 526. In further embodiments, a second cursor 530 indicates one or more lines of code in the code window 512 corresponding to the values indicated by the cursor 528.

In some embodiments a user can utilize applications such as those shown in FIG. 5 to examine simulation results of an electronic circuit design. In one example, the user sets the cursor 528 at a desired location in the window 520. This can correspond to displaying a first indicator (e.g., as in method act 210 of method 200). For the purposes of this example, the first indicator is a time value (4235000) identifying the amount of time since the beginning of the simulation. This time value is associated with an entry in the data set 140 (e.g., as in method act 220 of method 200). In some embodiments, this can be done by identifying a tuple in the data set 140 which most closely corresponds to the time value provided as the first indicator. A starting point in the data set is selected (e.g., as in method act 410), which for the purposes of this example is assumed to be the beginning of the data set 140, corresponding to the beginning of the simulation described by the data set 140. To determine the second indicator, entries from the data set 140 can be used to recreate the values simulated as being written to registers and/or memories of the electronic circuit design. That is, a model of registers and memories of the circuit design can be created and/or modified according to the transactions described in the data set 140 (e.g., as in method acts 420, 422). Once the model has been modified using data set transactions through the time identified by the first indicator (or, in some embodiments, shortly before or after this time), a second indicator can be provided to the application in the window 510 from the model (e.g., as in method act 430).

In the present example, the watch windows 514, 516 can be updated with values related to the second indicator. The source code window 512 can also be updated to display a portion of code (e.g., in box 530) that was simulated as being executed by the electronic circuit design at the time indicated by the cursor 528 in the window 520. In some embodiments, values for registers and/or variables can be determined by reading values directly from the data model, while a portion of source code can be associated with the indicated time by examining the portion of the data model corresponding to a program counter or similar device. Generally, a program counter value can be mapped to a source code instruction through a lower-level instruction, e.g., an assembly code instruction. In some embodiments, the above acts are repeated as a user drags one of the cursors 528, 530 over multiple values in the window 520 or over lines of code in the window 512. In further embodiments, the second indicator comprises one or more values in one or more watch windows 514, 516 (e.g., one or more variable or register values).

In the present example, a data model was created by starting at the beginning of the data set 140 and proceeding “forward” (i.e., chronologically) in the file until the data set tuple associated with the first indicator was reached. However, in some embodiments, the data model can be modified from a known state other than from the beginning of the simulation. In further embodiments, the data model can be modified by proceeding chronologically “backward” in the data set 140. In such embodiments, a transaction to the data model can be “undone” by writing to the register or memory location a prior value associated with the transaction, such as a value stored in column 328 of the data set portion 300. Such embodiments can be useful in cases where, for example, a data model with known values already exists and the first indicator requires determining values for an earlier or later time, such that modifying the data model from its current state would involve fewer transactions than modifying the model from the beginning of the simulation.

As can be seen from the foregoing and following examples, embodiments of the systems and methods described herein can allow a user to more easily and efficiently examine the outputs of an electronic circuit design simulation. As described above, a user can select a time point or points in a description of simulation outputs, which can cause corresponding register, memory and other values to be determined.

In a further example, a first indicator is provided when a user selects one or more lines of code from a listing such as that appearing in the window 512. In this embodiment, the second indicator is determined (method act 220) by identifying a program counter value corresponding to the selected code line(s), and using one or more data set tuples, as is similarly described above. In some embodiments a particular line of code can correspond to more than one tuple in the data set (e.g., if the line of code is in a loop). Accordingly, this feature can be configured to be made available for one or more portions of the code for which a particular data set tuple can be determined.

Features often found in debugger applications, such as breakpoints, stepping into, stepping out, etc., can be used with technologies described herein. Thus, some embodiments can be configured, for example, to allow a user to step through a software program while observing changes in memory, registers and/or other hardware structures of the circuit design.

Other user interface features can be used with embodiments of the disclosed technologies. For example, in some embodiments a mouse cursor or other cursor can be placed over or near a line of code in a listing of code from the software executable. Using the systems and techniques described herein, in response to the placement of the cursor, values for one or more registers and/or memory locations can be displayed. In some embodiments, these one or more values can be displayed near the cursor as cursor-responsive supplemental information, such as a “tooltip.”

### Exemplary Embodiments for Analyzing an Electronic Circuit Design in a Multi-Processor Environment

One or more of the technologies described herein can be adapted for use in a multi-processor environment. Described below are embodiments of a non-intrusive debug environment that shows, for example, a correlated software debug view of multiple processors (e.g., multiple digital signal processors (DSPs)). This view can be correlated to a waveform view of hardware external to the processors. In some embodiments, any of the views can be advanced (e.g., single-stepped, or run), which will simultaneously advance one or more other processor views. Various embodiments include the ability to backtrack, or step the system backward through time to previous states, so that causal conditions can be diagnosed. This system works with, for example, various representations of supporting external hardware, including transaction-level modeling (TLM), RTL and gate-level.

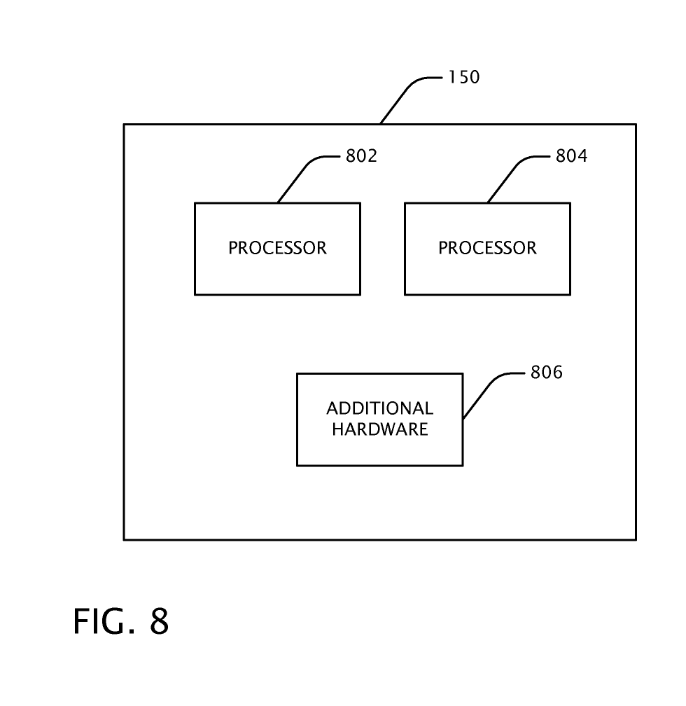

FIG. 8 shows a block diagram conceptually illustrating an exemplary circuit description 150 of a multi-processor electronic circuit design that may be analyzed using embodiments of the disclosed technologies. In the depicted embodiment, the description 150 comprises two processors 802, 804 as well as additional hardware components 806 (e.g., memories, memory controllers, communication interfaces such as Ethernet or Universal Serial Bus (USB) controllers, and ASIC or FPGA logic). Additional embodiments comprise any number of additional processors. In particular embodiments, two or more processors are, for example, physically located on the same circuit board, in the same computer and/or located in different computers that are coupled to each other (e.g., via a network). Embodiments of the disclosed technologies are also able to analyze simulation results for “multi-core processors” where two or more processors are physically located on one die and/or in one semiconductor package (e.g., the Pentium D processor from Intel Corp. or the ARM11-MPCore from ARM Ltd.). In various embodiments the processors 802, 804 operate based on the same clocks or on different clocks and operate, for example, with some of the same hardware components 806 or with some different hardware components 806. In some embodiments the processors 802, 804 are of the same design, while in other embodiments they are of different designs. In at least some embodiments, the processors 802, 804 can execute software programs causing them to perform one or more inter-processor synchronization events. In particular embodiments, the processors 802, 804 and/or the additional hardware components 806 can be described using one or more clock-cycle accurate representations (e.g., in an RTL representation).

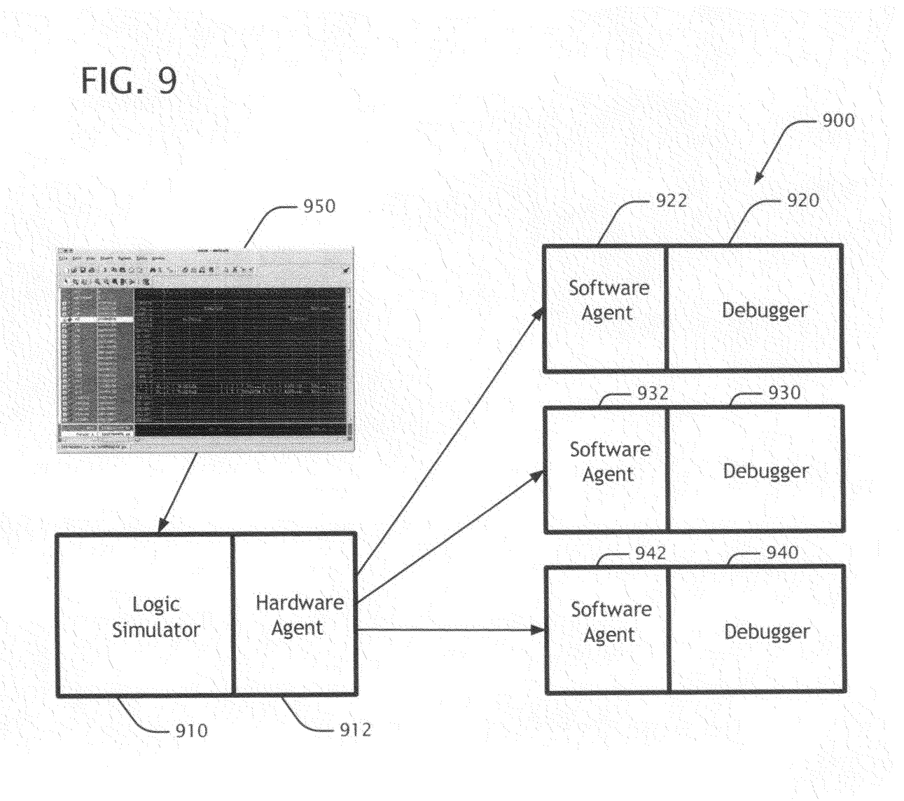

FIG. 9 shows a block diagram of one exemplary embodiment of a software system 900 for displaying simulation results in a multi-processor environment using technologies similar to those described above (e.g., with respect to FIGS. 1-5). In some embodiments the same software program is simulated as being executed on all of the processors, while in some embodiments different software programs are simulated as being executed on the various processors in the electronic circuit design. A simulator 910 (e.g., a logic simulator such as ModelSim) is configured to communicate with a plurality of debugger programs 920, 930, 940 (e.g., one for each processor in the system for which results are being simulated) which display simulation results and/or software status information for their respective processors. In particular embodiments the logic simulator 910 communicates via a hardware agent program 912 and one or more respective software agent programs 922, 932, 942. The hardware agent 912 and/or the software agent programs 922, 932, 942 can be implemented using, for example, a program such as Codelink from Mentor Graphics Corp. Further embodiments also comprise a display program 950 which can show simulation results (e.g., waveforms, numerical values) for one or more of the processors. In at least some embodiments, the combination of components in the system 900 allows a user to view simulation results for multiple processors, as well as hardware activity external to the processors. In this context, “hardware activity” includes operations which are simulated as occurring in the additional hardware components 806 as a result of a software operation. As an example of hardware activity, a software program executing on a processor 802, 804 executes a write operation to a register in the additional hardware components 806.

In some embodiments the logic simulator 910 receives an indication to change the simulated values displayed in the debugger programs 920, 930, 940 (e.g., a user moves the position of a cursor in a window showing simulation results). The logic simulator 910 passes information regarding the change to the debugger programs 920, 930, 940, which can then update the respective simulation results and/or software status information displayed.

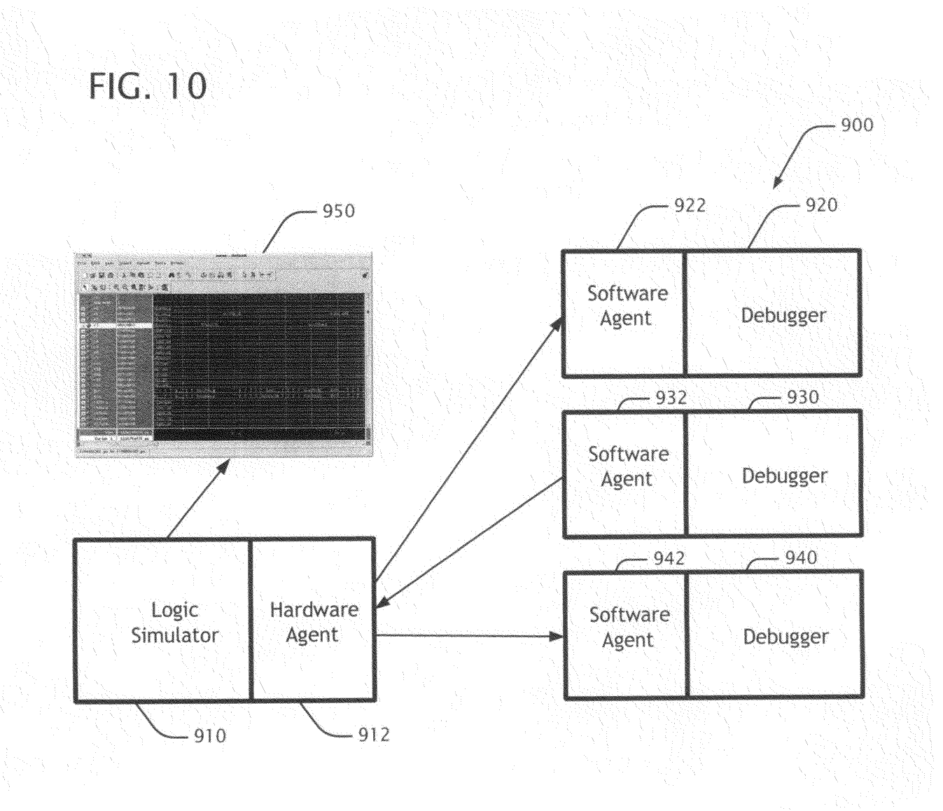

FIG. 10 shows a block diagram of the system 900 and how it functions when an indication to change the displayed simulation results and/or software status information is first received by one of the debuggers 920, 930, 940 rather than the logic simulator 910. In the depicted scenario, the debugger 930 receives the indication (e.g., from a user, a script or other source) and passes the indication to the logic simulator 910. The logic simulator 910 then provides the indication to the remaining debugger programs 920, 940. Thus, in selected embodiments, if the displayed simulation results and/or software status information is changed in one debugger, some or all of the remaining debuggers and/or the logic simulator will also change the results they display.

Technologies for displaying simulation results using systems such as those described by FIGS. 8-10 (e.g., systems with multiple processors and multiple debuggers) are described below.

In at least some embodiments, the availability of simulation results at a given time in the simulation is not necessarily uniform across different components of the electronic circuit design (e.g., for various processors and/or additional hardware components). When simulation results are described in this application as being “available” for a circuit design component at a given time, this refers to simulation results containing data for the component at the given time. Non-uniformity of simulation results across circuit design components can be due, for example, to differences in processor architecture, differences in clock signals, and/or differences in software programs being executed by the processors.

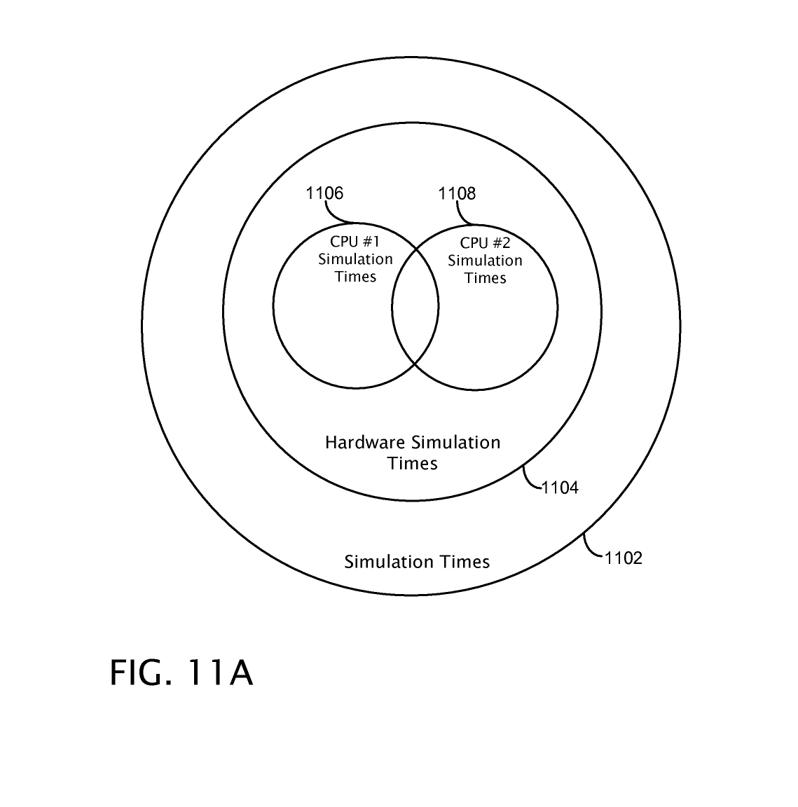

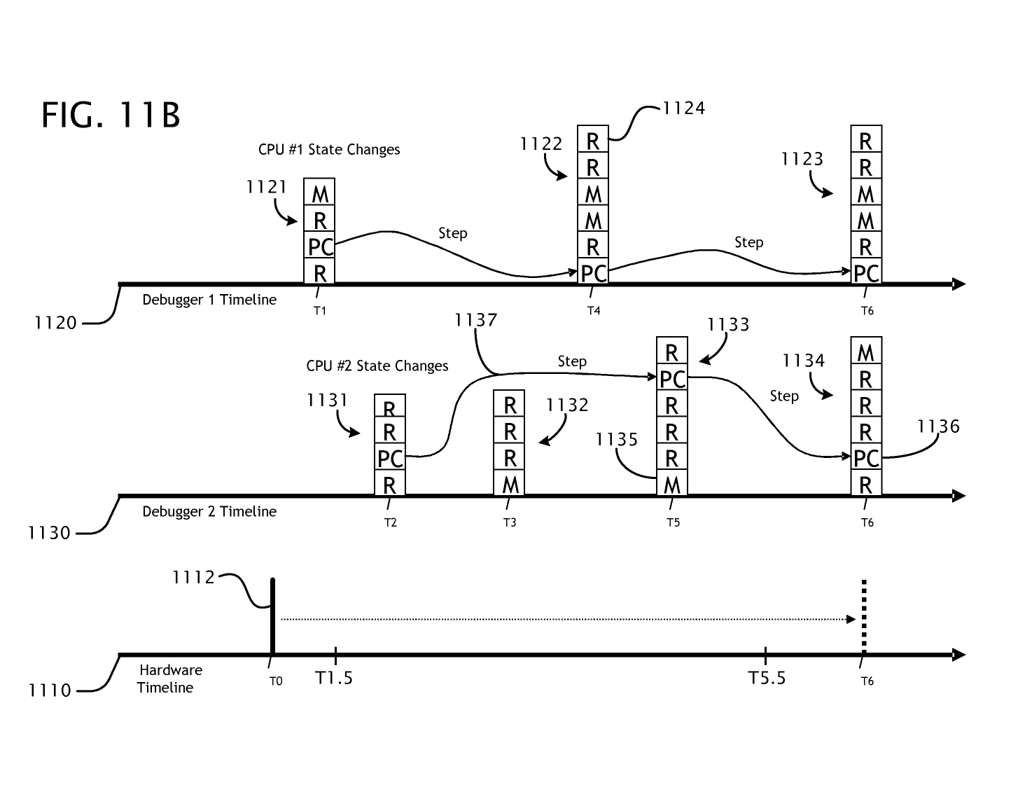

A diagram in FIG. 11A depicts the availability of simulation results in at least some cases. Circle 1102 represents all possible times in a simulation for which results could be available. Circle 1104 represents the times for which simulation results are available for the additional hardware components 806, and these times are a subset of the circle 1102. Circles 1106, 1108 represent simulation times for which results are available for two processors, CPU #1 and CPU #2, respectively. Generally, the simulation results available for the additional hardware components 806 are more numerous than the simulation results available for at least one of the processors (though technologies described herein can also be used with simulation results where this is not the case).

FIG. 11B shows exemplary timelines 1110, 1120, 1130 indicating the availability of simulation results shown in a system such as the system 900 between simulated points in time T0 and T6. In particular embodiments, one or more timelines such as those shown in FIG. 11B can be used as part of a user interface (UI) component for operation of the system 100, e.g., in conjunction with displaying one or more waveforms describing simulation results. However, the timelines of FIG. 11B are also generally useful in understanding the disclosed technologies.

A timeline 1110 represents a chronological range of available hardware simulation results for the additional hardware components 806. When the timeline 1110 is implemented as part of a UI, hardware simulation results for one or more points in time are selected according to the position of one or more cursors such as cursor 1112, and the selected simulation results can be displayed using, for example, the display program 950.

Timelines 1120, 1130 show state changes in two processors (CPU #1 and CPU #2, respectively), as displayed by the processors' respective debuggers. For example, simulation results indicate that CPU #1 has state changes 1121, 1122 and 1123 at times T1, T4 and T6, respectively, while CPU #2 has state changes 1131, 1132, 1133 and 1134 at times T2, T3, T5 and T6, respectively. The stacked boxes at each state change represent the changes occurring in the respective processor's state during the simulation: a box labeled “M” (e.g., box 1135) represents a read and/or a write to a memory location in the electronic circuit design; a box labeled “R” (e.g., box 1124) represents a read and/or write to a register location in the circuit design; and a box labeled “PC” (e.g., box 1136) represents a change in the respective processor's program counter. Sometimes, one or more of the processors are pipelined devices that concurrently execute multiple instructions within a processor. However, for ease of presentation, some embodiments of the disclosed technologies present multiple events (e.g., program counter changes, memory changes and/or register changes) as occurring in discrete groups like those shown in FIG. 11B. In some embodiments a program counter change is grouped with its resulting memory read/write and/or its resulting register change. Further embodiments can be configured to represent various events as they occur, rather than as one or more groups of events.

The arrows on timelines 1120, 1130 labeled “step” (e.g., arrow 1137) indicate the states that a debugger can go to while stepping from a given previous state to a next state. In at least some embodiments, a debugger's step function moves only from a first state change with a program counter change to a second state change with a program counter change. So, for example, the step arrow 1137 in the timeline 1130 goes from the state change 1131 at T2 to the state change 1133 at T5, skipping over the state change 1132 at T3, which does not indicate a change to the program counter.

If the system 100 is requested to display simulation results for a selected point on the timeline 1110 (e.g., as a result of user input), the system 100 can display state change data describing the state changes in the one or more processors using and/or in the additional hardware components 806. Such information can be displayed using, for example, a UI such as that described above with respect to FIG. 5. In the embodiment of FIG. 11B, “state change data” comprises at least some of the information shown on timelines 1120, 1130. For example, if the system 100 is requested to display simulation information for the time T6, the system 100 can display information describing the state changes for CPU #1 and CPU #2 at the time T6. Such features can simplify the analysis of simulation results for multi-processor systems.

In further embodiments, the selected point on the timeline 1110 is a point in time at which the simulation results indicate no state change data is available for one or more processors in the electronic circuit design. For example, the time T5.5 on timeline 1110 does not directly correlate to any state changes in CPU #1 or CPU #2. In some embodiments, in cases where a point such as T5.5 is selected, the system 100 can display information from the nearest point in time when state changes in the processors occur. For example, if the selected point on the timeline 1110 is T5.5, the system 100 will display processor state change information for time T6. In at least some UI embodiments, this can be represented by a cursor on a timeline that moves (“snaps”) from a position indicated by user input to a position for which the simulation results indicate processor state change data is available. To continue with the previous example, if a user places a cursor at the time T5.5 on the timeline, the system 100 would move the cursor to the time T6 on the timeline.

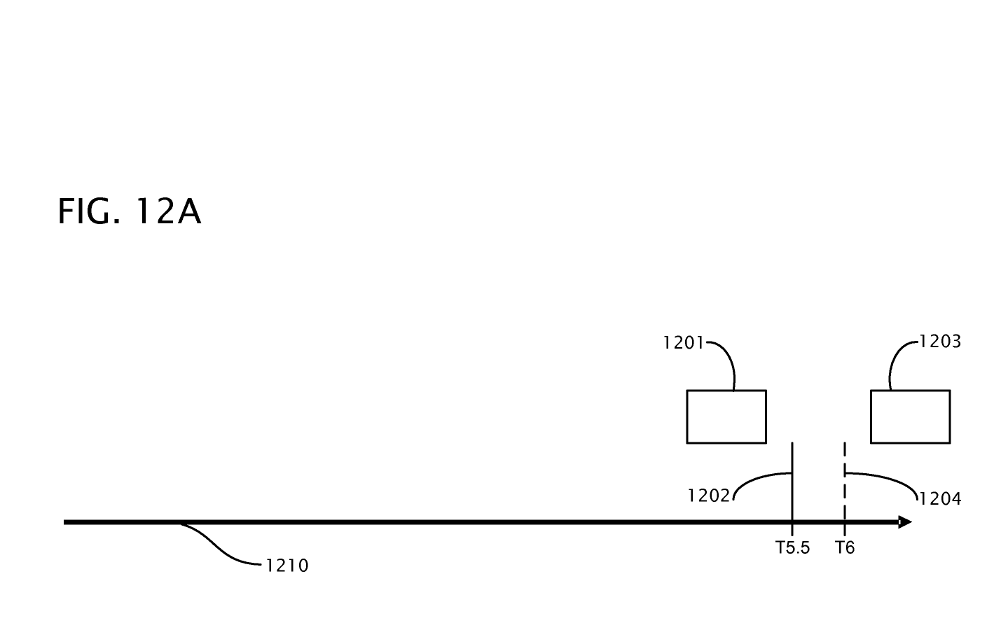

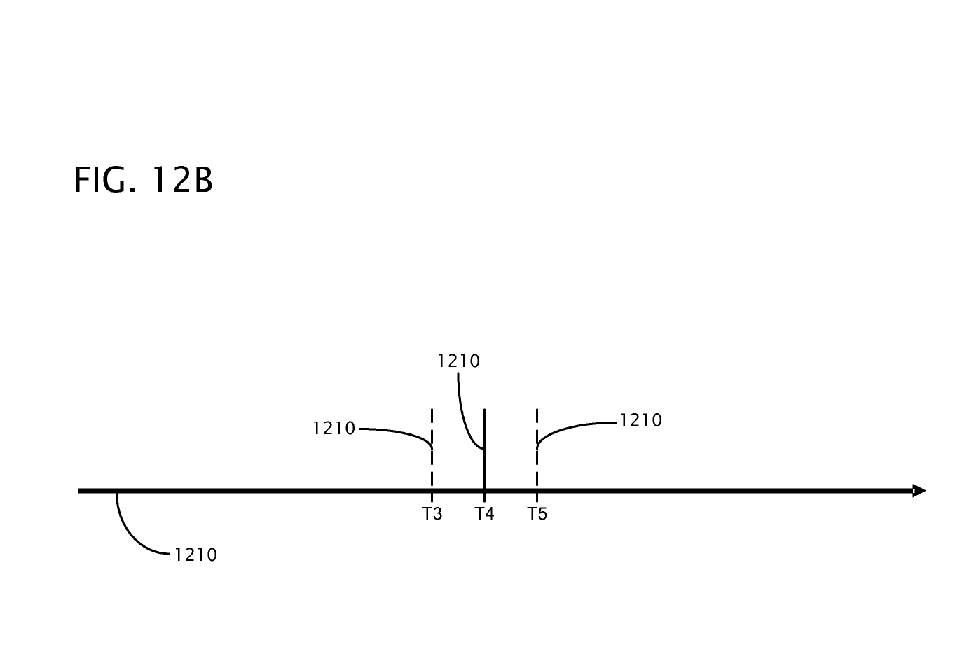

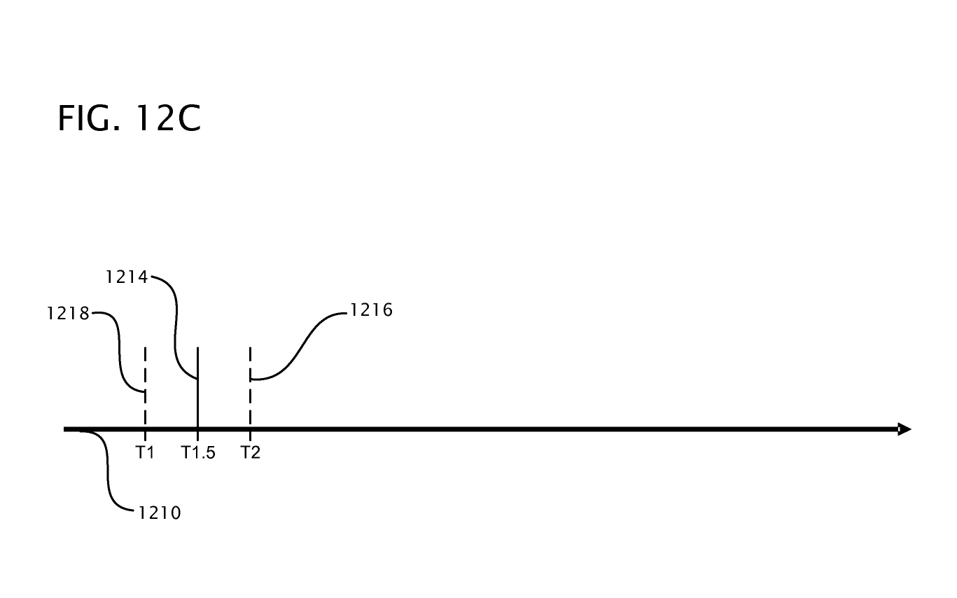

In further embodiments, the cursor is not necessarily moved from one point to another as described immediately above. As shown in FIG. 12A, in at least some cases, a first cursor 1202 is displayed on a timeline 1210 in the time position designated (e.g., by user input), while a second cursor 1204 is displayed at a position indicating a time (e.g., the nearest time) for which state change data is available in the simulation results. Further embodiments display one or more additional cursors showing one or more additional times for which state change data is available in the simulation results. In at least some embodiments, regions such as regions 1201, 1203 identify the processors to which the cursors 1202, 1204 correspond. Further embodiments display in the regions 1201, 1203 information (e.g., software state information) related to one or more processors to which the cursors 1202, 1204 correspond. In particular embodiments the regions 1201, 1203 appear in a separate UI window.

As seen in FIG. 11B, sometimes the state changes in two given processors occur at the same time (e.g., timelines 1120, 1130 show that CPU #1 and CPU #2 both experience a state change at the time T6). However, in at least some embodiments one or more state changes occur in one of the processors at one or more times when a state change is not occurring in at least one other processor. For example, FIG. 11B shows that CPU #1 has a state change at time T4, but not at times T3 or T5. CPU #2, on the other hand, has a state change at times T3 and T5, but not at time T4. In some embodiments, if the selected point on the timeline 1110 corresponds to a point when simulation results indicate processor state change data is available for a first processor, but unavailable for a second processor, the system 100 displays a first cursor at the selected point and a second cursor at a position corresponding to a point for which state change data is available for the second processor. For example, as shown in FIG. 12B, a cursor 1206 can be displayed at the time T4 (indicating the selected point on the timeline 1210, as well as a point for which state change data is available for CPU #1), and a cursor 1208 can be displayed at the time T5 (indicating a point for which state change data is available for CPU #2). In further embodiments, one or more additional cursors, such as cursor 1212, can indicate one or more additional time points for which state change data is available.

In further embodiments, the selected point (e.g., T1.5) on the timeline 1110 is a point for which state information is available for neither CPU #1 nor CPU #2, and the nearest time point for which state information is available is not common to both processors. In such cases, the system 100 can move (“snap”) a cursor to a neighboring time point for one processor and show another cursor at a neighboring time point for another processor. Various methods can be used for determining which neighboring time point to snap to (e.g.: the nearest time point to the selected point; the immediately next time point after the selected time point, if the simulation results are being traversed in chronological order; the immediately previous time point before the selected time point, if the simulation results are being traversed in reverse chronological order). In further embodiments, and as shown in FIG. 12C, the system 100 can show a cursor 1214 at the selected point, and then show additional cursors 1216, 1218 indicating points in time for which state change data is available for the processors. That is, the cursor 1214 is displayed at a point where state information is available for neither CPU #1 nor CPU #2.

As suggested by FIGS. 12A-12C, cursors can be presented with varying visual characteristics (e.g., color, pattern) to indicate whether the cursor corresponds to a selected point on a timeline, or whether the cursor indicates a neighboring point for which state change data is available. In some embodiments, cursors such as cursors 1204, 1208, 1212, 1216, 1218 cannot be moved by a user (e.g., by clicking and dragging in a UI), and the relative positions and/or appearances of these cursors can be considered as representing a type of “rounding error” made by the system 100 in presenting simulation results for one or more of the processors in the electronic circuit design.

Although at least some of the foregoing embodiments describe displaying simulation result data for multi-processor circuit designs using a “timeline” model, further embodiments can use other methods for displaying the simulation results (e.g., tables, graphs and/or text).

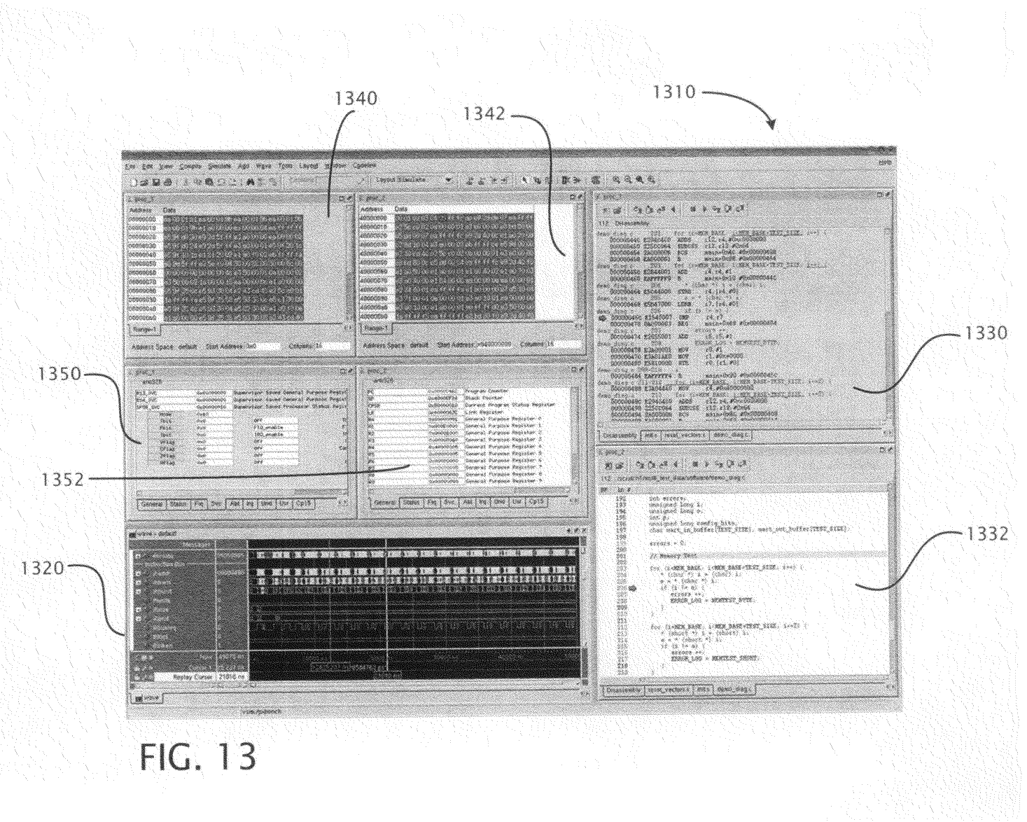

FIG. 13 shows exemplary embodiments of applications used in conjunction with embodiments described elsewhere in this application, particularly for viewing simulation results of multi-processor circuit designs. Similar to the exemplary applications shown above in FIG. 5, the applications of FIG. 13 can be presented with a number of user interfaces, for example a window-based GUI 1310. In the depicted embodiment a window 1320 comprises variable waveforms and register waveforms presented along a time axis. The GUI 1310 further comprises computer code windows 1330, 1332, memory watch windows 1340, 1342, and register watch windows 1350, 1352. Windows 1330, 1340, 1350 display data associated with a first processor, while windows 1332, 1342, 1352 display data associated with a second processor. In some embodiments a window associated with a given processor in the circuit design is distinguishable by a text label, color label, or other indicator.

Technologies described above with respect to FIGS. 8-13 can be used in conjunction with technologies described elsewhere in this application. For example, the data set of FIG. 3 can be modified for use with a multi-processor circuit design. In some embodiments a data set can include an indication that a given tuple is associated with a given processor. Additionally, in some embodiments a user view simulation results for a multi-processor system can view data for multiple processors without advancing the state of the processors, since at least some of the displayed simulation results are based on the simulation's data set. Stepping forward or backward in a debugger for one processor causes debugger views for one or more other processors to change.

In further embodiments, technologies described herein can be used with results obtained from actual physical circuit design components, rather than from simulated circuit design components. For example, a dataset similar to that described above with respect to FIG. 3 can be created at least in part based on signals produced during the operation of one or more processors and/or one or more other hardware components. Portions of the dataset can be created based on information collected from an execution trace buffer in a physical processor, such as the ETM (embedded trace module) in an ARM processor. Additional information concerning the operations of the circuit design can be obtained from a logic analyzer or similar technology. Technologies described herein can also be used for analyzing electronic circuit designs that are at least in part emulated.

### Exemplary Computer Networks

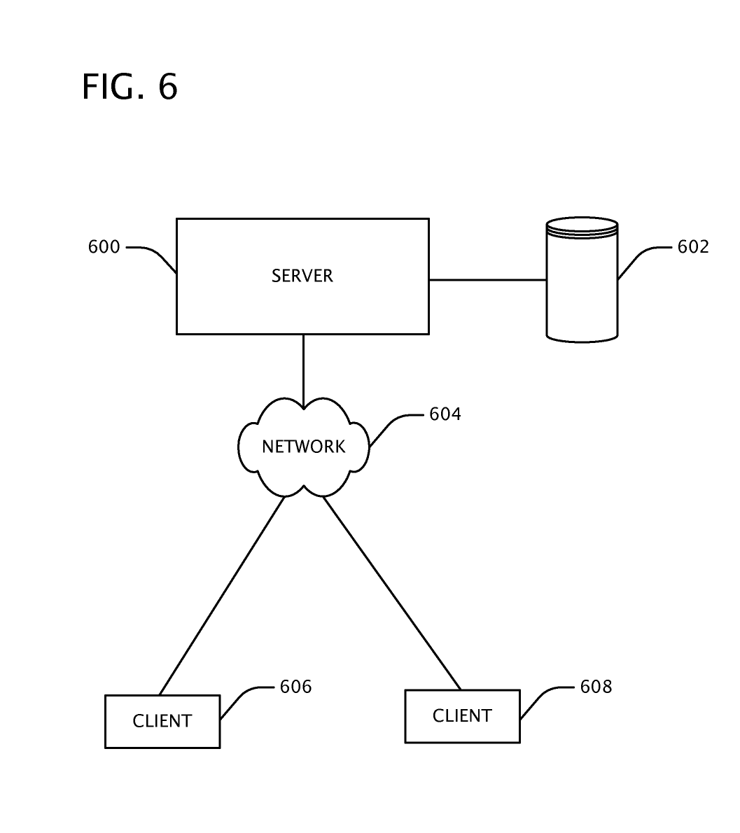

Any of the aspects of the technologies described above can be performed using a distributed computer network. FIG. 6 shows one such exemplary network. A server computer 600 can have an associated storage device 602 (internal or external to the server computer). For example, the server computer 600 can be configured to display circuit simulation results according to any of the disclosed embodiments (e.g., as part of an EDA software tool, such as a logic simulator or a software debugger tool). The server computer 600 can be coupled to a network, shown generally at 604, which can comprise, for example, a wide-area network, a local-area network, a client-server network, the Internet, or other such network. One or more client computers, such as those shown at 606, 608, can be coupled to the network 604 using a network protocol.

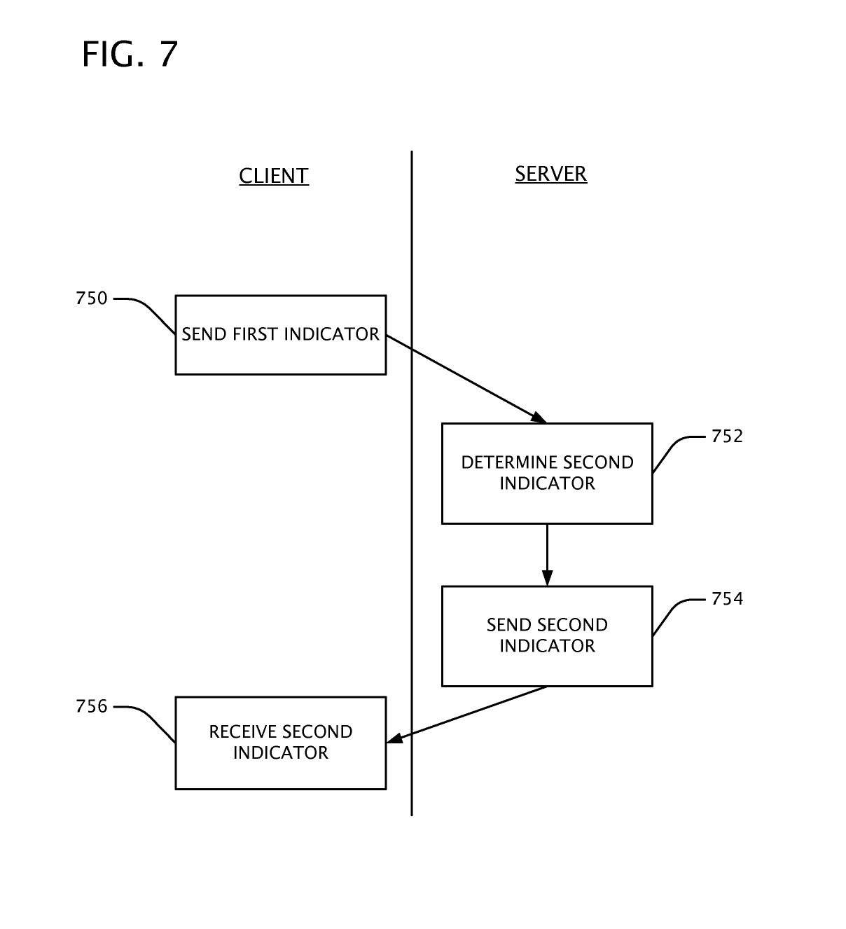

FIG. 7 shows one exemplary manner in which the distributed network shown in FIG. 6 may operate to display circuit simulation results. In particular, a first indicator can be used to determine a second indicator according to any of the embodiments disclosed herein using a remote server computer, such as the server computer 600 shown in FIG. 6. In method act 750, for example, the client computer sends a first indicator to the server computer. In method act 752, a second indicator is determined by the server computer. In method act 754, the server computer sends the second indicator to the client computer, which receives the second indicator in method act 756.

It should be apparent that the example shown in FIG. 7 is not the only way to analyze simulation results according to the disclosed technology. For instance, a first indicator can be stored on a computer-readable medium that is not on a network and that is sent separately to the server (e.g., on a CD-ROM or other computer-readable medium). Moreover, the server computer may perform only a portion of the determination procedure.

Having shown and described the principles of the illustrated embodiments, it will be apparent to those skilled in the art that the embodiments can be modified in arrangement and detail without departing from such principles. For example, any of the embodiments described herein need not be performed over a distributed computer network. In view of the many possible embodiments, it will be recognized that the illustrated embodiments include only examples and should not be taken as a limitation on the scope of the invention.

We claim:

1. A system for analyzing results of a simulation of an electronic circuit design comprising a first processor, a second processor and one or more additional hardware components, the system comprising:
a logic simulator configured to display simulation results for the one or more additional hardware components;
a first software debugger program configured to display information comprising simulation results related to the first processor or information describing a simulated status of a software program simulated as being executed on the first processor;
a second software debugger program configured to display information comprising simulation results related to the second processor or information describing a simulated status of a software program simulated as being executed on the second processor; and
one or more software components configured to communicate changes in displayed information in one of the logic simulator, the first debugger program and the second debugger program to the others of the logic simulator, the first debugger program and the second debugger program.

2. The system of claim 1, further comprising a software component configured to receive a command to change information displayed in one of the logic simulator, the first debugger program and the second debugger program.

3. The system of claim 2, wherein the software component configured to receive the command to change information displayed is on a first computer, and wherein at least one of the logic simulator, the first debugger program, the second debugger program and the one or more software components configured to communicate changes in displayed information is on a second computer.

4. The system of claim 2, wherein the command is a step command.

5. The system of claim 2, wherein the command is a backward step command.

6. The system of claim 1, wherein the simulation results for the one or more additional hardware components are obtained using a clock-cycle accurate model of the additional hardware components.

7. One or more computer-readable media comprising instructions configured to cause a computer to perform a method for analyzing results of a simulation of a first software program being executed on a first processor in an electronic circuit design and a second software program being executed on a second processor in the electronic circuit design, the method comprising:
receiving a first indication of simulation results for the first processor at a first indicated time;
identifying one or more simulation results for the second processor according to a description of a plurality of values simulated as being stored in the electronic circuit design, wherein the identified one or more simulation results for the second processor correspond at least approximately to the first indicated time; and
storing the identified one or more simulation results for the second processor in one or more computer-readable media.

8. The one or more computer-readable media of claim 7, wherein the description of a plurality of values simulated as being stored in the electronic circuit design comprises:
at least one time indicator for the simulation;
a first write address indicator identifying first one or more data storage locations described in the electronic circuit design;
a second write address indicator identifying second one or more data storage locations described in the electronic circuit design;
a first write value indicator identifying one or more values simulated as being written by the first processor to the first one or more data storage locations described in the electronic circuit design; and
a second write value indicator identifying one or more values simulated as being written by the second processor to the second one or more data storage locations described in the electronic circuit design.

9. One or more computer-readable media comprising instructions configured to cause a computer to display a user interface for displaying results of a simulation of an electronic circuit design, the user interface comprising:
a region configured to display at least a portion of the simulation results;
a first indicator in a first position on the display associated with an approximate chronological point in the simulation results for which the description of the plurality of values simulated as being stored in the electronic circuit design indicates that simulation results are available for a first processor in the electronic circuit design; and
a second indicator in a second position on the display, wherein the second position is associated with an approximate chronological point in the simulation results for which a description of a plurality of values simulated as being stored in the electronic circuit design indicates that simulation results are available for a second processor in the electronic circuit design.

10. The one or more computer-readable media of claim 9, wherein the first position is a user-selected position.

11. The one or more computer-readable media of claim 9, wherein the display comprises a timeline.

12. The one or more computer-readable media of claim 9, wherein the user interface further comprises a third indicator in a third position on the display, and wherein the third position is a user-selected position.

13. The one or more computer-readable media of claim 12, wherein the first indicator is displayed at the first position before the third indicator is displayed at the third position.

14. The one or more computer-readable media of claim 12, wherein the first indicator and the third indicator are displayed such that the third indicator appears to move from the third position to the first position.

15. The one or more computer-readable media of claim 9, wherein the user interface further comprises a region displaying test result data associated with the first processor.

16. The one or more computer-readable media of claim 9, wherein the user interface further comprises an indication of a synchronization event between the first processor in the electronic circuit design and a second processor in the electronic circuit design.

17. A method of analyzing results of a simulation of an electronic circuit design, the method comprising:
displaying a first portion of simulation results for a first processor in the electronic circuit design;
displaying a first portion of simulation results for a second processor in the electronic circuit design;
displaying a first portion of simulation results for a non-processor component in the electronic circuit design;
receiving an indication to display a second portion of simulation results for the first processor; and
displaying the second portion of simulation results for the first processor, a second portion of simulation results for the second processor, and a second portion of simulation results for the non-processor component.

18. The method of claim 17, wherein the indication is received using a user interface element comprising a timeline showing availability of simulation results for at least part of the electronic circuit design.

19. The method of claim 17, wherein the indication corresponds to a point in time in the simulation results for which simulation results for the second processor are not available, and wherein the second portion of simulation results for the second processor comprises the simulation results for the second processor that are closest to the point in time in the simulation results.

20. The method of claim 17, further comprising determining at least a part of the second portion of the simulation results for the first processor according to a description of values simulated as being stored in the electronic circuit design.

21. One or more computer-readable media comprising instructions configured to cause a computer to perform a method for analyzing a physical or emulated electronic circuit, the circuit comprising a first processor, a second processor, and one or more additional hardware components, the method comprising:
displaying a first set of previous signal values produced by the one or more additional hardware components during operation of the electronic circuit design;
displaying a first set of previous signal values generated as a result of a software program being executed on the first processor;
displaying a first set of previous signal values generated as a result of a software program being executed on the second processor;
receiving an indication to display and displaying one of a second set of previous signal values produced by the one or more additional hardware components during operation of the electronic circuit design, a second set of previous signal values generated as a result of a software program being executed on the first processor, or a second set of previous signal values generated as a result of a software program being executed on the second processor; and
displaying the others of the second set of previous signal values produced by the one or more additional hardware components during operation of the electronic circuit design, the second set of previous signal values generated as a result of a software program being executed on the first processor, or the second set of previous signal values generated as a result of a software program being executed on the second processor.
